(19) United States
(12) Patent Application Publication
(10) Pub. No.: US 2017/0288285 A1
(43) Pub. Date: Oct. 5, 2017

(54) LIQUID TEMPERATURE REGULATED BATTERY PACK FOR ELECTRIC VEHICLES

(71) Applicant: Faraday&Future Inc., Gardena, CA (US)

(72) Inventors: Kameron Fraige Saad Buckhout, Inglewood, CA (US); John Henry Harris, III, San Gabriel, CA (US)

(21) Appl. No.: 15/261,427

(22) Filed: Sep. 9, 2016

Related U.S. Application Data
(60) Provisional application No. 62/317,137, filed on Apr. 1, 2016.

(51) Int. Cl. H01M 10/6568; H01M 2/20; H01M 10/625; H01M 2/10; H01M 10/0525

(52) U.S. Cl. CPC H01M 10/6568; H01M 2/1077; H01M 10/0525; H01M 10/625; H01M 2/206; H01M 2220/20

(57) ABSTRACT

Systems and methods for liquid temperature regulated energy storage in electric vehicles are disclosed. Systems can include an enclosure and a channel passing through the enclosure. The channel can include an inlet for liquid inflow and an outlet for outflow of the liquid, the outlet in fluid communication with the inlet. The channel can be defined by at least two thermally conductive plates disposed on opposite sides of the channel. The plates can be configured to be placed in to thermal contact with at least one battery. The channel can be a flow path for a liquid coolant.

### RELATED APPLICATIONS

Any and all applications for which a foreign or domestic priority claim is identified in the Application Data Sheet as filed with the present application are hereby incorporated by reference under 37 CFR 1.57. This application claims the benefit of U.S. Provisional Application No. 62/317,137, filed Apr. 1, 2016, entitled “LIQUID TEMPERATURE REGULATED BATTERY PACK FOR ELECTRIC VEHICLES.” This application is also related to attorney docket number FARA.059A2, filed on the same day as the present application, and also claiming priority to U.S. Provisional Application No. 62/317,137. Each of the above-identified applications are hereby incorporated by reference in their entirety.

### TECHNICAL FIELD

The present disclosure is related to battery temperature control systems. More particularly, a battery pack having an internal heating/cooling path for a liquid is described herein.

### BACKGROUND

Large lithium ion battery packs require that the individual battery cells within them be regulated in temperature during operation. Such battery packs may employ a cooling system having air cooled heat sinks (passive airflow or fan assisted). Other cooling systems use liquid cooling where the batteries are immersed in a liquid coolant and is circulated around the batteries. The liquid can also be heated to warm the batteries.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiment” one will understand how the features of the system and methods provide several advantages over traditional systems and methods.

Some implementations include a battery housing having an enclosure and a channel passing through the enclosure. The channel may have an inlet for liquid inflow and an outlet in fluid communication with the inlet and for outflow of the liquid. The channel may be defined by at least two thermally conductive plates disposed on opposite sides of the channel. The plates may be configured to be in thermal contact with at least one battery. A dielectric fluid may flow through the channel.

In some implementations, a method of making a battery housing includes one or more of the following steps. The method may include forming a first support for at least one battery. The first support may have a first outwardly exposed thermally conductive surface. The method may also include forming a second support for at least one battery. The second support may have a second outwardly exposed thermally conductive surface. The method may include, for example, coupling the first support to the second support to form a channel in between the first and second thermally conductive surfaces. The channel may have an inlet for liquid inflow and an outlet in fluid communication with the inlet and for outflow of the liquid. The coupling step may include forming a fluid tight seal between the first support and the second support. The forming step may include injecting molding a plastic over an aluminum plate.

Some implementations include a system including at least one flow path for a liquid coolant. At least one pump may circulate the coolant through the flow path. At least one heater may heat the coolant in the flow path. At least one heat exchanger may cool the coolant in the flow path. At least two battery cell supports may be spaced apart by a flow path. The at least two battery cell supports may contain a plurality electrochemical cells. The electrochemical cells may each have a first end and a second end on an opposite side of the first end. The second ends may be secured in thermal contact with opposing sides of the flow path. A battery housing may be coupled to the flow path. The battery housing may enclose a plurality of electrochemical cells disposed therein. The housing may be configured such that coolant from the flow path is in thermal contact with at least two opposing sides of the electrochemical cells disposed therein. The plurality of electrochemical cells in the housing may be configured to have a higher terminal voltage than the electrochemical cells in the supports.

### BRIEF DESCRIPTION OF THE DRAWINGS

The following is a brief description of each of the drawings. From figure to figure, the same reference numerals have been used to designate the same components of an illustrated embodiment. The drawings disclose illustrative embodiments and particularly illustrative implementations in the context of connecting a plurality of electrochemical cells. They do not set forth all embodiments. Other embodiments may be used in addition to or instead. Conversely, some embodiments may be practiced without all of the details that are disclosed. It is to be noted that the Figures may not be drawn to any particular proportion or scale.

FIG. 1 is a schematic illustration of an electric vehicle having two battery systems according to an exemplary implementation. As shown, the first battery system powers one or more high voltage loads and the second battery system powers one or more low voltage loads.

FIG. 2 is a left-side perspective view of an exemplary implementation of a battery housing. As shown, the housing may include a plurality of substantially cylindrical electrochemical cells.

FIG. 3 is a right-side perspective view of the housing of FIG. 2 with the cell retaining wall removed.

FIG. 4 is a perspective view of the battery housing of FIG. 2 with the cell cover walls removed.

FIG. 5 is a cross-sectional view of FIG. 2 about the line 5-5.

FIG. 6 is a cross-sectional view of FIG. 2 about the line 6-6.

FIG. 7 is a cross-sectional view of FIG. 2 about the line 7-7.

FIG. 8 in an exploded perspective view of the housing of FIG. 2.

FIG. 9 is an exploded perspective view of the channel assembly.

FIG. 10 is a perspective view of the assembled channel assembly of FIG. 9.

FIG. 11 is a perspective view of an exemplary implementation of a battery housing including battery connection circuitry.

FIG. 12A is a schematic diagram illustrating an exemplary implementation of a cooling system for an electric vehicle.

FIG. 12B is a schematic diagram, similar to FIG. 12A, illustrating another exemplary implementation of a cooling system for an electric vehicle.

### DETAILED DESCRIPTION OF THE PREFERRED EMBODIMENTS

Disclosed herein is battery pack having at least one cooling channel disposed therein. The cooling channel may be formed by two cooling plates that are spaced apart by a gap. The cooling plate may form a wall of an enclosure. The remaining walls of the enclosure may be formed of material that is not as thermally conductive as the cooling plate. For example, the cooling plate may include aluminum and the remaining portions of the enclosure may include a plastic. The enclosure may house a plurality of electrochemical cells, such as, for example, lithium ion battery cells. Other types of electrochemical cells are also contemplated. Liquid coolant may be circulated through the channel. Thus, the channel may have an inlet and an outlet and the liquid coolant may flow from the inlet to outlet. In some aspects the channel includes a flow divider. The fluid may be configured to flow in a U-shape-like path from the inlet to the outlet.

Typical electric vehicles almost exclusively draw their power from one high capacity, high voltage battery system. The high capacity, high voltage battery system is used to power the motors that propel the vehicle and is stepped down with one or more DC-DC converters to power other electrically powered systems. When the high capacity, high voltage battery system is not engaged, for example, when the vehicle is parked, a lower capacity, lower voltage battery may be relied upon. This second battery may function as a typical automobile battery and may be used to start the vehicle and power other components such as, for example, the windows, door locks, and stereo when the high capacity, high voltage battery is disengaged. The second battery is typically recharged by the high capacity, high voltage battery when the vehicle is driving and/or when the high voltage battery system is engaged.

The high voltage battery system may be configured to power the vehicle components that require relatively high voltages. For example, the high voltage battery system may be configured to power one or more electric motors that are used to propel the vehicle. The low voltage battery system may be configured to power the vehicle components that require relatively lower voltages in comparison to the high voltage battery system. For example, the low voltage battery system may be configured to power the cabin HVAC system(s), the windows, the locks, the doors, the audio and entertainment systems, infotainment systems, wireless modems and routers, touch screens, displays, navigation systems, automated driving systems, and the like. Low voltage systems or components may generally refer to systems or components that require less voltage than the motors that propel the vehicle.

A vehicle with at least two separate high capacity energy storage systems can have several advantages. For one, the low voltage system can power vehicle systems for long periods of time without engaging the high voltage battery system. Energy is lost when electric power is moved between battery systems. For example, DC-DC converters are not perfectly efficient and energy is lost when a DC-DC converter is operated. Thus, if the low voltage system has sufficient storage capabilities, it can be used to power systems other than the propulsion motors for longer periods of time and the need for recharging the low voltage system and/or the need to draw power from the high voltage system, may be reduced or eliminated.

A relatively high capacity, low voltage battery may require a heating and/or cooling system. At very low temperatures, the electrochemical cells in the high capacity, low voltage battery pack may not be capable of powering the required loads. High temperatures may cause battery failure and/or fire.

The following description is directed to certain implementations for the purpose of describing the innovative aspects of this disclosure. However, a person having ordinary skill in the art will readily recognize that the teachings herein can be applied in a multitude of different ways.

As used herein, the term “electric vehicle” can refer to any vehicle that is partly or entirely operated based on stored electric power, such as a pure electric vehicle, plug-in hybrid electric vehicle, or the like. Such vehicles can include, for example, road vehicles (cars, trucks, motorcycles, buses, etc.), rail vehicles, wheeled robots, or the like.

In some implementations, the word “battery” or “batteries” will be used to describe certain elements of the embodiments described herein. It is noted that “battery” does not necessarily refer to only a single battery cell. Rather, any element described as a “battery” or illustrated in the Figures as a single battery in a circuit may equally be made up of any larger number of individual battery cells and/or other elements without departing from the spirit or scope of the disclosed systems and methods.

Reference may be made throughout the specification to a “12 volt” power systems or sources. It will be readily apparent to a person having ordinary skill in the art that the phrase “12 volt” in the context of automotive electrical systems is an approximate value referring to nominal 12 volt power systems. The actual voltage of a “12 volt” system in a vehicle may fluctuate as low as roughly 4-5 volts and as high as 16-17 volts depending on engine conditions and power usage by various vehicle systems. Such a power system may also be referred to as “low voltage” battery systems. Some vehicles may use two or more 12 volt batteries to provide higher voltages. Thus, it will be clear that the systems and methods described herein may be utilized with low voltage battery arrangements in at least the range of 4-34 volts without departing from the spirit or scope of the systems and methods disclosed herein.

The present disclosure may be implemented to achieve one or more advantages other traditional battery cooling systems. In some aspects, the amount of coolant that is required is minimized. For example, by utilizing the disclosed geometry, the channel can allow the liquid to cool two physically separated sets of battery cells at the same time.

In certain aspects, the present system may be less expensive to manufacture than previous systems. For example, certain aspects achieve the desired heat conduction properties while primarily relying on components made of low cost plastics. Manufacturing time may also be reduced and/or simplified. For example, two halves of the housing may be substantially similar and include only one conductive surface each. These two halves may be joined in one step to form a cooling channel in between the two halves.

Such enclosures can also be configured as modular battery packs having the desired electrical characteristics. The modular packs may be added and/or removed as needed. For example, if a user desires extra battery lifetime, additional packs may be easily added to the system. In some aspects, the modular packs may be connected to a cooling system that is also used to cool/heat the higher voltage batteries that are used to power the vehicles propulsion motors and/or drivetrain. Thus, additional pumps, fans, heat exchangers, and the like may not be required. In some aspects, the inlet and the outlet for coolant are located on the same side of the housing such that connection to coolant lines is simplified. In some implementations, the outlet is located at a high point such that air bubbles may be more readily expelled from the coolant path.

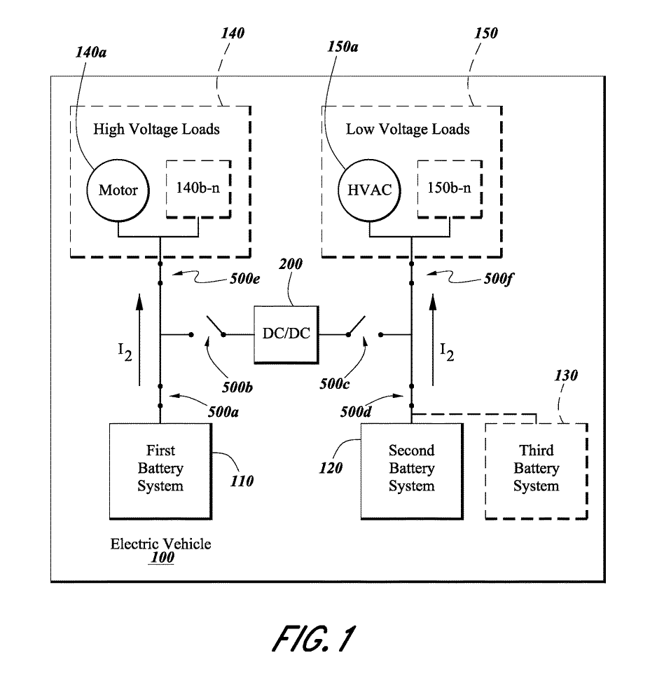

FIG. 1 schematically illustrates an electric vehicle 100 having a first battery system 110 and a second battery system 120. The first battery system 110 may be electrically connected to one or more high voltage loads 140. The first battery system 110 may include one or more batteries connected in series and/or in parallel. The first battery system 110 may be controlled by one or more battery controllers or battery control systems (not shown). Such controllers may include circuitry capable of regulating and/or controlling the available voltage differences and/or current.

The one or more high voltage loads 140 may include an electric motor 140a. The electric motor 140a may be configured to propel the vehicle 100. The electric motor 140a may be an interior permanent magnet motor. One or more inverters may also be provided. It should be appreciated that while the motor 140a is an electrical machine that can receive electrical power to produce mechanical power, it can also be used such that it receives mechanical power which it converts to electrical power. Additional loads 140b-n may also be electrically connected to the first battery system 110. The additional loads 140b-n may include, for example, additional motors, power train components, and the like.

As shown in FIG. 1, current I₁ from the first battery system 110 may flow to the one or more high voltage loads 140. That is to say, the first battery system 110 may power the one or more high voltage loads 140a-n. A switch 500b in the open position is shown between the first battery system 110 and a DC/DC converter 200. Thus, current I₁ does not flow from the first battery system 110 to the one or more low voltage loads 150a-n nor to a second battery system 120.

The second battery system 120 may be electrically connected to one or more low voltage loads 150. The second battery system 120 may include one or more batteries connected in series and/or in parallel. The second battery system 120 may be controlled by one or more battery controllers (not shown).

The one or more low voltage loads 150 may include an HVAC 150a. The HVAC 150a may be configured to heat, cool, and/or circulate air through the vehicle's passenger cabin. The HVAC 150a may include various types of heating, cooling, and ventilation components. For example, the HVAC 150a may include one or more heating elements, seat heaters, floor heaters, defrosters, deicers, fans, filters, air conditioners, compressors, and the like.

Additional loads 150b-n may also be electrically connected to the second battery system 120. The additional loads 150b-n may include, for example, additional motors (e.g. for windows, door locks, sun roofs, compartments), audio system components, infotainment system components, computers, navigation system components, mobile phones, electrical outlets, refrigerators, and the like. A battery management system (not shown) may also be used to regulate the voltage/current that is supplied to the one or more low voltage loads 150a-n.

As shown in FIG. 1, current I₂ from the second battery system 120 may flow to the one or more low voltage loads 150a-n. That is to say, the second battery system 120 may power the one or more low voltage loads 150a-n.

A DC-DC converter 200 may be used to connect the first and second battery systems. Switches 500a-e may be provided. A switch 500c in the open position is shown between the second battery system 120 and the DC/DC converter 200. Thus, current I₂ does not flow from the second battery system 120 to the one or more high voltage loads 140a-n nor to the first battery system 110. While switches 500a-e are shown in FIG. 1, other control mechanisms may be used. Current controllers and/or battery controllers and/or DC-DC converter controllers may be utilized to control which battery system(s) is (are) utilized. The DC-DC converter 200 may be a bidirectional DC-DC converter.

In some aspects, the electric vehicle 100 may include a third battery system 130. The battery system 130 may have a capacity that is less than the capacity of both the first and the second battery system. The third battery system 130 may be used to power one or more battery control systems, switches, contactors, essential low voltage components and the like. In some aspects, the third battery system 130 is configured analogously to a standard starting, lighting, and ignition automobile battery. The third battery system 130 may be used, for example, to engage and/or disengage the first and/or second battery systems 110, 120. In some aspects, the third battery system 130 is included in a standard electric vehicle and the second battery system 120 is provided as an add-on feature. The third battery system 130 may be used to power the one or more switches 500a-e. The third battery system 130 may be re-charged by the first 110 and/or second battery system 120.

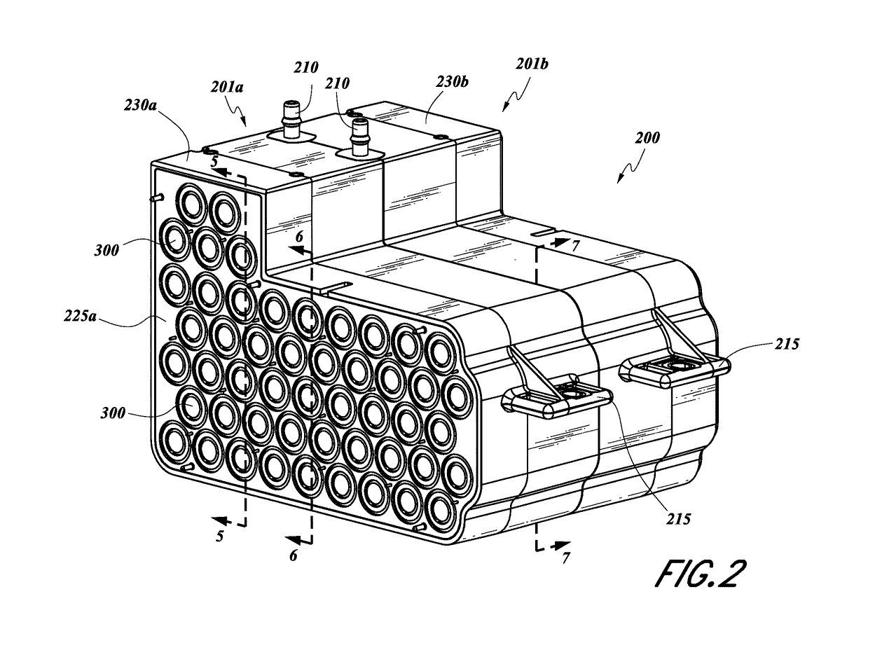

Turning to FIG. 2, a battery housing 200 according to an exemplary implementation is illustrated. FIG. 2 is a left-side perspective view of the housing 200. The housing 200 may be formed by coupling a left housing part 201a with a right housing part 201b. A plurality of electrochemical cells 300 may be placed into the housing 200. In the illustrated embodiment, fifty cells 300 are placed in the left housing part 201a and fifty cells 300 are placed in the right housing part 201b. Thus, the housing 200 includes one hundred total cells 300. However, any number of cells 300 may be included in the housing 200 and/or the housing parts 201a, 201b.

The cells 300 may be cylindrical in shape and have two circular ends that are opposite one another. The side of the cells 300, visible in FIG. 1, may include a positive terminal and a negative terminal disposed thereon. The cells 300 may be electrically connected in parallel and/or in series with circuitry (not shown). For example, each of cells 300 may have a positive terminal and a negative terminal disposed on the outward-facing circular face of the cells 300. A left cell retaining wall 225a may at least partially secure the cells 300 in the left housing 201a. A right cell retaining wall 225b (not shown in FIG. 1) may at least partially secure the cells 300 in the right housing 201b. The cell retaining walls 225a, 225b may be formed of plastic.

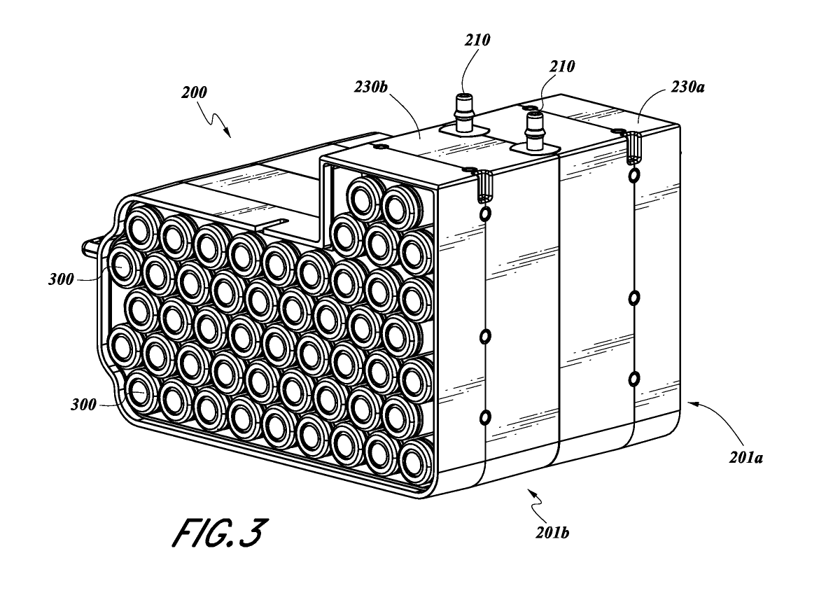

FIG. 3 is a right-side perspective view of the housing 200 with the cell retaining walls 225a, 225b removed. Left and right cell cover walls 230a, 230b may cover the lengthwise portions of the cylindrical cells 300.

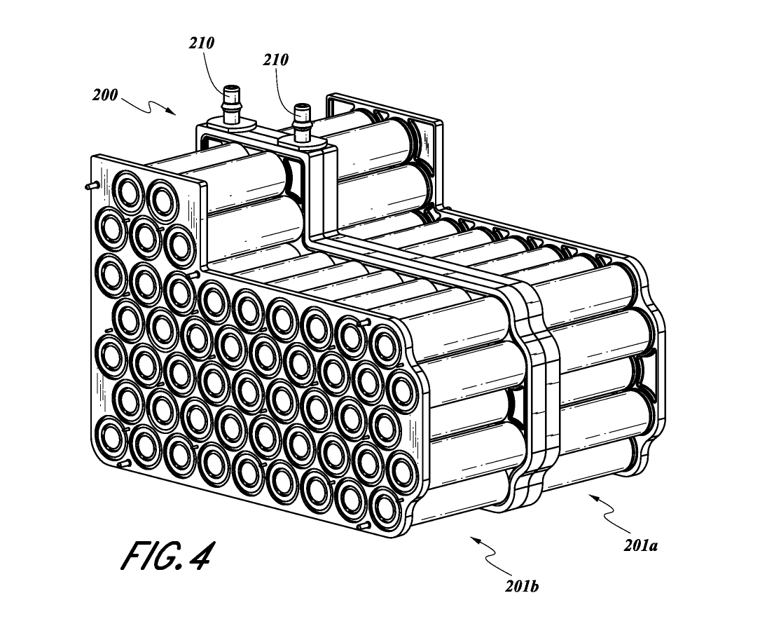

FIG. 4 is a left-side perspective view of the housing 200 with the cell cover walls 230a, 230b removed. The cell cover walls 230a, 230b may be plastic.

Referring again to FIG. 2, brackets 215 may be provided. The brackets 215 may be used to at least partially secure the housing 200 to the vehicle and/or to a subcomponent of the vehicle configured to support a battery housing 200. Coolant inlet/outlets 210, described further below, may be provided on the top side of the housing 200 to permit the ingress and egress of coolant.

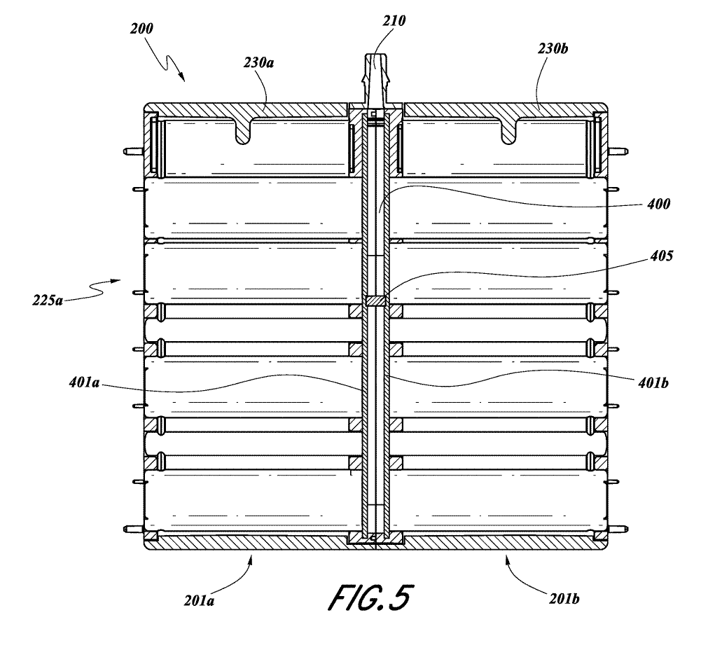

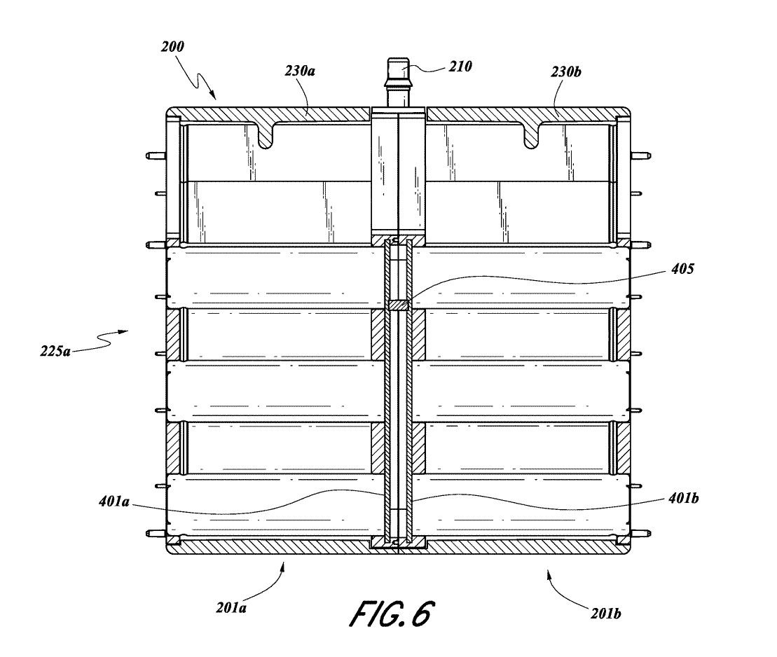

The cross-sectional views in FIGS. 5-6 illustrate that the housing 200 includes a channel 400 disposed therethrough. The channel 400 may be at least partially defined by two thermally conductive plates 401a and 401b. That is to say, the plates 401a and 401b may be spaced apart by a gap. The plates 401a, 401b may be formed of aluminum or any other thermally conductive material, such as another metal. A flow diverter 405 may be disposed within the channel 400. Liquid coolant may be pumped into one of the inlet/outlet 210 and out of the other inlet/outlet 210. The liquid coolant may be any suitable coolant. For example, the liquid coolant may be a dielectric coolant. The coolant may be configured to transfer heat from the plates 401a, 401b to the coolant. In some embodiments, coolant or cooling liquid or cooling fluid may include, for example, one or more of the following: synthetic oil, polyolefin (e.g., poly-alpha-olefin (“PAO”)), ethylene glycol, ethylene glycol and water, and phase change materials (“PCM”).

As will be understood, at least one side of the cells 300 may be placed into thermal contact with the plates 401a, 401b. Preferably, the side of the cell placed into thermal contact with the plates 401a, 401b is the side that is opposite to the side of the cell 300 that includes the positive and negative terminal. The cells 300 may be secured into place with an adhesive. Preferably, the adhesive is an epoxy having a high thermal heat transfer coefficient. In this way, heat generated from the cells 300 may flow from the cells 300 to the plate 401a, 401b and into the coolant that flows through the channel 400. In some aspects, when the temperature of the cells 300 is below the desired operating temperature, the coolant may be heated and heat may flow from the coolant to the plates 401a, 401b in order to heat the cells 300.

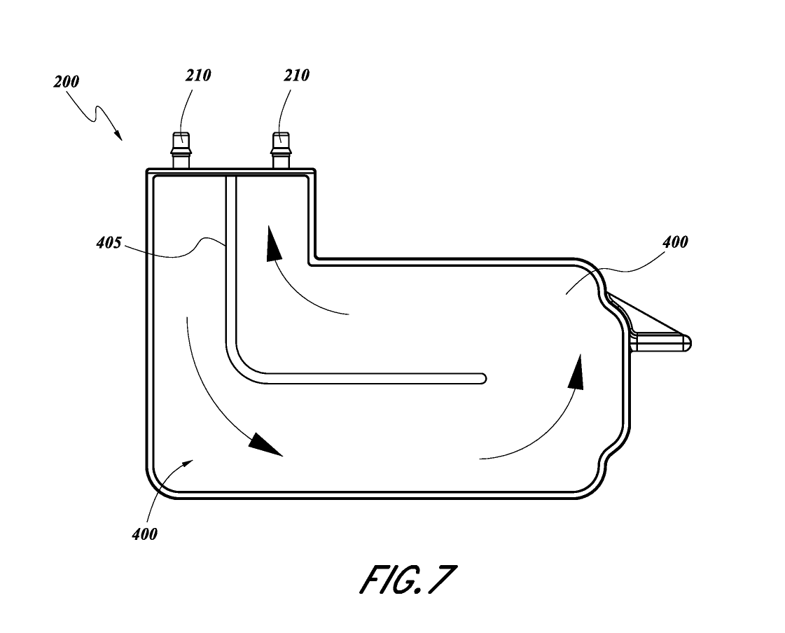

The cross-section view of FIG. 7 illustrates that the coolant may be configured to circulate through the housing 200. For example, the flow diverter 405 in the channel 400 may direct fluid in path from one inlet/outlet 210 to the other inlet/outlet 210. In some aspects, the flow path may include at least one substantially U-shaped bend. While the coolant flow is shown as traveling in the counterclockwise direction, the opposite direction of fluid flow is also contemplated. In some aspects, flowing coolant in the counterclockwise direction may allow for the coolant to warm and thus naturally rise as it moves towards the outlet 210.

The coolant flow configuration depicted in FIG. 7 may also be desirable for the removal of air or other gas pockets, such as bubbles, that may exist within the channel 400. Fluid free areas may form within the coolant, for example, by cavitation and/or by leaks or other points of ingress for air or other gases into the coolant system. Bubbles formed elsewhere in a coolant system may be carried into the channel 400 with coolant liquid entering at an inlet/outlet 210. In some aspects, the counterclockwise coolant flow helps ensure that the coolant is travelling in a generally upward direction as it passes through the u-shaped bend. The buoyant force exerted on bubbles in the channel 400 can combine with the force exerted by the motion of the coolant to more efficiently propel bubbles free of any obstructing structure within the u-shaped bend region of the channel 400 and in the direction of the coolant outlet 210. Similarly, the location of one or both of the coolant inlet/outlet 210 along the topmost surface of the housing 200 may further aid in the removal of fluid-free regions. For example, at least the outlet 210 can be located along the topmost surface of the housing 200 such that the buoyant force exerted on submerged bubbles tends to move the bubbles upward through the channel 400 to the outlet 210, where the bubbles can pass out of the housing 200.

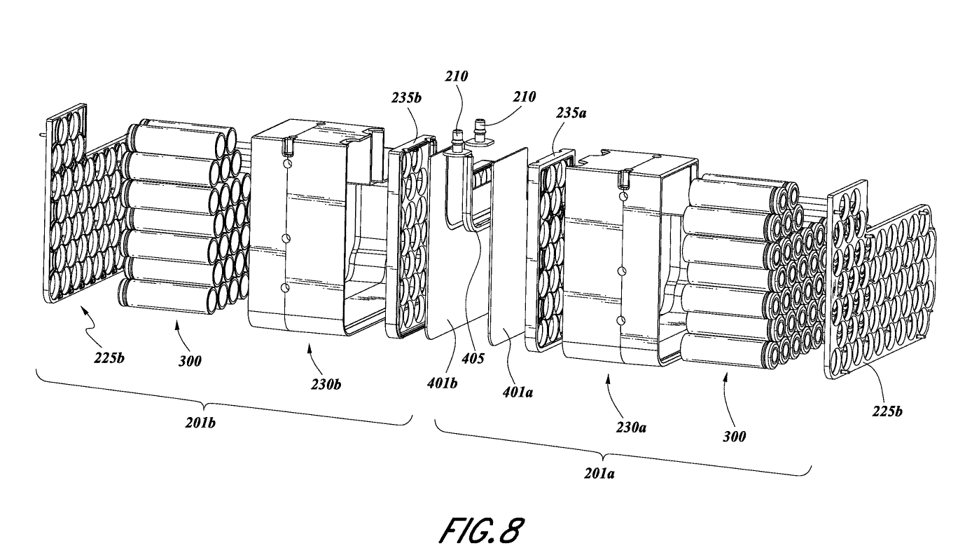

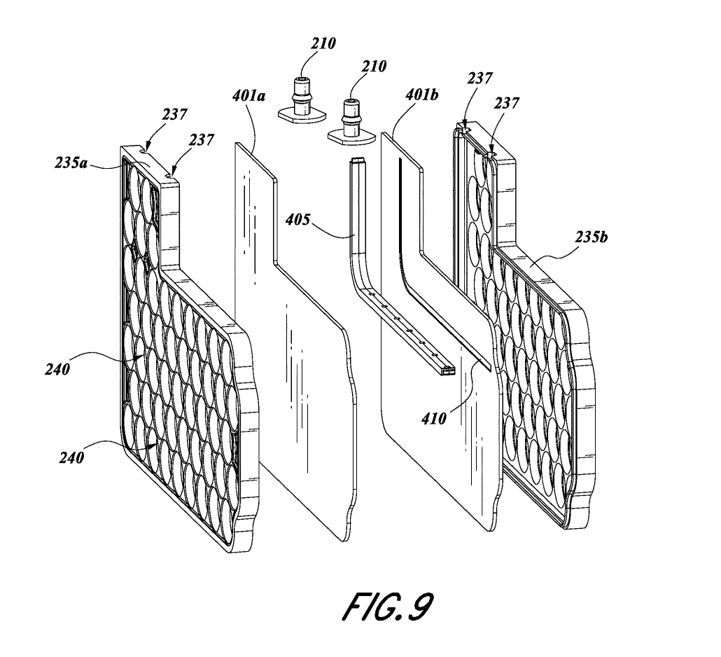

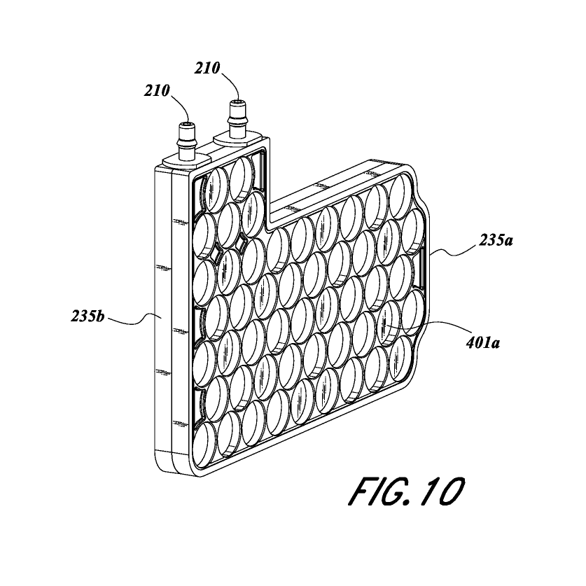

FIG. 8 is an exploded view of the housing 200. As shown, each housing part 201a, 201b may include an outer cell retaining wall 225a, 225b, a cell cover wall 230a, 230b, an inner cell retaining wall 235a, 235b, and a thermally conductive plate 401a, 401b. The cell retaining wall 225a, 225b, cell cover wall 230a, 230b, and inner cell retaining wall 235a, 235b may be formed of a material that is not as thermally conductive as the plate 401a, 401b. For example, these parts may be formed of plastic and the plate 401a, 401b may be formed of metal. In some aspects, two housing halves 201a, 201b are sealed together to form a housing 200 having an internal coolant flow path or channel, as depicted in FIG. 7. The inner cell retaining walls 235a, 235b, plates 401a, 401b, and flow diverter 405 are further detailed in FIGS. 9-10.

The housing may be manufactured according to the following method. While the steps are described in a particular order, other ordering of the steps is possible. FIG. 9 illustrates an exploded view of the channel assembly. The assembled channel assembly is shown in FIG. 10. An inner retaining wall 235a, 235b and plate 401a, 401b may be formed in a single step. For example, the inner retaining wall 235a, 235b may be manufactured using an injection molding process over the plate 401a, 401b. The inner retaining wall 235a, 235b may include a plurality of cell carriers 240. The carriers 240 may be sized and shaped to at least partially receive a portion of a cell 300. The two opposing inner retaining walls 235a, 235b may be secured together such that a gap is formed in between the two plates 401a, 401b. The two opposing inner retaining walls 235a, 235b may be coupled together such that a fluid tight seal is created. The gap between the plates 401a, 401b may form a coolant channel 400.

As shown in FIG. 9, a flow diverter 405 may be inserted into a groove 410 in one or both plates 401a, 401b. The groove 410 may be stamped and or machined into either one or both of the plates 401a, 401b. The flow diverter 405 may be further secured to the plate(s) 401a, 401b with an adhesive. The inner cell retaining walls 235a, 235b may include at least two pre-formed openings halves 237 which can be coupled to the inlet/outlets 210 to form a fluid inlet and a fluid outlet. Coolant may be pumped into the inlet and flowed over the plates 401a, 401b to transfer heat to and/or from the plates 401a, 401b. The coolant may exit an outlet 210.

In other implementations, the cell cover wall 230a, 230b, inner cell retaining wall 235a, 235b, and plate 401a, 401b are formed in a single step. For example, the cell cover wall 230a, 230b, inner cell retaining wall 235a, 235b, and plate 401a, 401b may be formed by injecting molding over a metal plate 401a, 401b. In other implementations, the outer retaining wall 225a, 225b, cell cover wall 230a, 230b, inner cell retaining wall 235a, 235b, and plate 401a, 401b are formed in a single step by injecting molding over a metal plate 401a, 401b.

Cells may be inserted into the cell carriers 240 of the inner retaining walls 235. An adhesive may be used to bond the cells to the plate 401a, 401b and/or the inner cell retaining wall 235a, 235b. The adhesive preferable has a high thermal heat transfer coefficient. The cell carriers 240 and/or the inner retaining walls 235a, 235b may thus form a support for at least a portion of the cells and inhibit the movement of the cells in at least the longitudinal, lateral, and/or transverse direction.

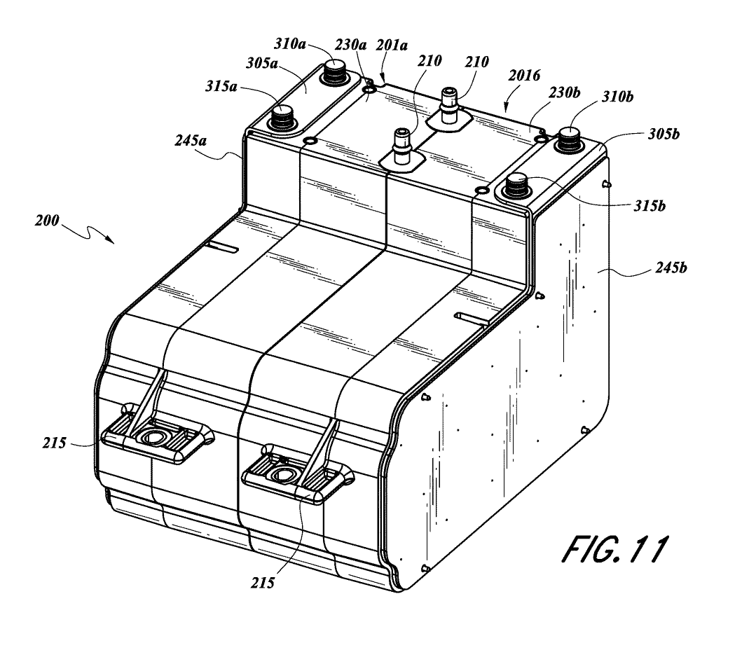

FIG. 11 depicts an assembled battery housing 200 which may include any of the components described above with reference to FIGS. 1-10. The housing 200 includes two parts 201a, 201b, including cell cover walls 230a, 230b. Brackets 215 may be attached to and/or integrally formed as a portion of the cell cover walls 230a, 230b. Coolant may be provided to and removed from the housing 200 at coolant inlet/outlets 210.

Battery cell connection circuits 305a, 305b may be provided to electrically couple the battery cells 300 (not shown in FIG. 11). Cell connection circuits 305a, 305b may include any type of electrical circuitry, such as a printed circuit board, flex circuit, wiring, or other conductive material or combination of conductive and insulating materials. In some aspects, the cell connection circuits 305a, 305b can be flex circuits configured to electrically couple with the positive and negative terminals of all battery cells so as to connect the cells in parallel, in series, or a combination of parallel and series connections. The cell connection circuits 305a, 305b can further be configured to connect the battery cells to a negative terminal 310a, 310b and a positive terminal 315a, 315b of each part 201a, 201b. Cell connection circuits 305a, 305b may be secured in place and/or protected by end cover walls 245a, 245b. In some aspects, end cover walls 245a, 245b may be composed of the same material as the cell cover walls 230a, 230b, and may be secured to the cell connection circuits 305a, 305b and/or other components of the housing 200 by heat staking.

The housing 200 includes two sets of batteries that are cooled by an internal common channel. The electrochemical cells are thus positioned such that the non-electric terminal ends are facing inward and are in thermal contact with the channel and the electric terminal ends are facing outward and electrically connected by cell connection circuits 305a, 305b positioned on either side of the housing 200. The cell connection circuits 305a, 305b may be configured to connect the cells in parallel or in series and provide a voltage difference between the positive terminals 315a, 315b and the negative terminals 310a, 310b. The cell connection circuits 305a, 305b may be disposed on opposite sides of, and parallel to, the common coolant channel. The common coolant channel may be oriented vertically within the housing 200 so as to facilitate fluid circulation through the channel and mitigate cavitation that may occur within the coolant in the channel.

Various electrical connections may be made with the assembled housing 200 at the terminals 310a, 310b, 315a, 315b. For example, in some implementations it may be desired to produce electrical power at the voltage provided by the cells contained in a single housing part 201a, 201b, and the parts 201a, 201b may be connected in parallel with a negative or ground connection coupled to both negative terminals 310a, 310b and a positive connection coupled to both positive terminals 315a, 315b. In some implementations it may be desired to produce electrical power at twice the voltage provided by the cells contained in a single housing part 201a, 201b, and the parts 201a, 201b may be connected in series by electrically coupling either the left negative terminal 310a with the right positive terminal 315b or the left positive terminal 315a with the right negative terminal 310b. The uncoupled negative terminal 310a or 310b can then be connected to a negative or ground connection, and the uncoupled positive terminal 315a or 315b can be connected to a positive connection. Electrical connections external to a battery housing 200 will be discussed in greater detail below with reference to FIGS. 13-18.

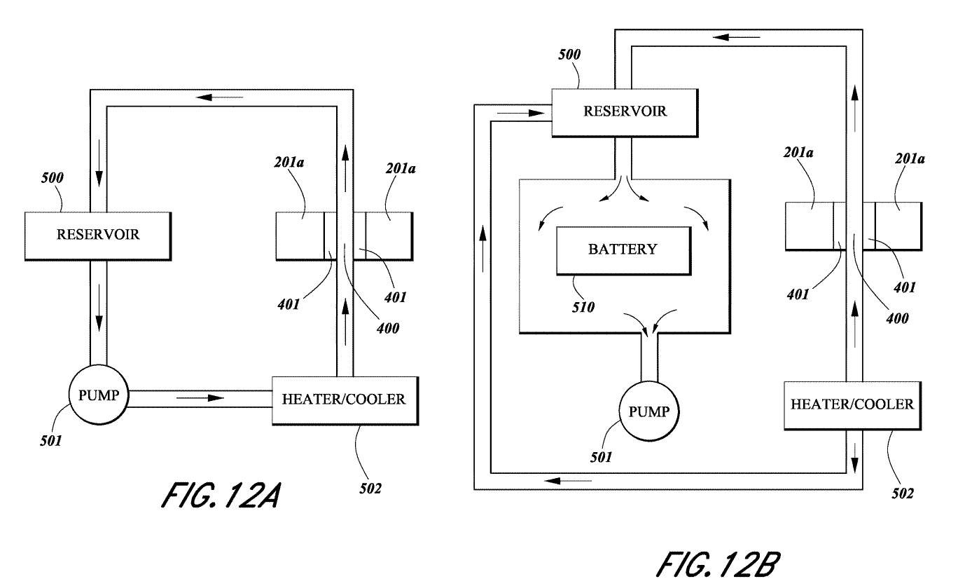

FIG. 12A schematically illustrates how the housing 200 may be implemented in an electric vehicle. As shown, liquid coolant may be pumped with a pump 501 through a heater and/or a cooler 502. The heater may raise the temperature of the coolant when necessary, for example, when the vehicle and/or the housing 200 is at a temperature lower than a desirable operating temperature. The heater may include an electric heater. The cooler may lower the temperature of the coolant when necessary, for example, when the vehicle and/or the housing 200 is at a temperature higher than a desirable operating temperature, such as due to a high ambient temperature, heat generated by battery cells 300, or heat generated by other components of the vehicle. The cooler may include a heat exchanger. The liquid coolant may then pass through the channel 400 and may heat and/or cool the cells as described above. The channel may be disposed in a housing comprising housing parts 201a and 201b as described above. The housing may house a low voltage battery system. The coolant may then flow through a reservoir 500 for excess coolant. It is noted that the components may be arranged in any order and are not limited to the configuration illustrated in FIG. 12A.

FIG. 12B schematically illustrates another implementation of the housing 200 in a battery cooling/heating system. As shown, the coolant may be circulated through the housing 200 (comprising housing parts 201a and 201b) as well as through a second housing that surrounds another battery 510. The battery 510 may include a high voltage battery system. It is noted that the components may be arranged in any order and are not limited to the configuration illustrated in FIG. 12B.

The foregoing description and claims may refer to elements or features as being “connected” or “coupled” together. As used herein, unless expressly stated otherwise, “connected” means that one element/feature is directly or indirectly connected to another element/feature, and not necessarily mechanically. Likewise, unless expressly stated otherwise, “coupled” means that one element/feature is directly or indirectly coupled to another element/feature, and not necessarily mechanically. Thus, although the various schematics shown in the Figures depict example arrangements of elements and components, additional intervening elements, devices, features, or components may be present in an actual embodiment (assuming that the functionality of the depicted circuits is not adversely affected).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the implementations are not limited to the precise configuration and components illustrated above. Various modifications, changes, and variations may be made in the arrangement, operation, and details of the methods and apparatus described above without departing from the scope of the implementations.

Although this invention has been described in terms of certain embodiments, other embodiments that are apparent to those of ordinary skill in the art, including embodiments that do not provide all of the features and advantages set forth herein, are also within the scope of this invention. Moreover, the various embodiments described above can be combined to provide further embodiments. In addition, certain features shown in the context of one embodiment can be incorporated into other embodiments as well.

What is claimed is:

1. A battery housing comprising:
an enclosure; and
a channel passing through the enclosure; the channel having an inlet for liquid inflow and an outlet in fluid communication with the inlet, for outflow of the liquid, the channel defined by at least two thermally conductive plates disposed on opposite sides of the channel, both plates configured to be placed into thermal contact with at least one battery.

2. The battery housing of claim 1, further comprising a liquid coolant in the channel.

3. The battery housing of claim 1, further comprising a plurality of electrochemical cells having a first end and a second end on an opposite side of the first end, the first end having a positive and a negative terminal disposed thereon, and the second end secured in thermal contact with the plates.

4. The battery housing of claim 3, further comprising a flex circuit adjacent to the first end of at least two of the plurality of electrochemical cells, the flex circuit configured to electrically connect the at least two electrochemical cells.

5. The battery housing of claim 4, wherein the housing comprises two flex circuits disposed on opposite sides of, and parallel to, the channel.

6. The battery housing of claim 1, comprising a plurality of enclosures coupled together.

7. The battery housing of claim 1, wherein the outlet is disposed along a top surface of the enclosure.

8. The battery housing of claim 7, wherein the inlet is disposed along the top surface of the enclosure.

9. A method of making a battery housing comprising:
forming a first support for at least one battery, the first support having a first outwardly exposed thermally conductive surface;
forming a second support for at least one battery, the second support having a second outwardly exposed thermally conductive surface;
coupling the first support to the second support to form a channel in between the first and second thermally conductive surfaces, the channel having an inlet for liquid inflow and an outlet in fluid communication with the inlet and for outflow of the liquid.

10. The method of claim 9, wherein the coupling includes forming a fluid tight seal between the first support and the second support.

11. The method of claim 9, wherein the forming a first support and second support includes injecting molding a plastic over an aluminum plate.

12. The method of claim 9, further comprising:
securing a plurality of electrochemical cells in thermal contact with the first outwardly exposed thermally conductive surface; and
securing a plurality of electrochemical cells in thermal contact with the second outwardly exposed thermally conductive surface,
wherein each electrochemical cell has a first end and a second end on an opposite side of the first end, the first end having a positive and a negative terminal disposed thereon, and the second end secured in thermal contact with either the first outwardly exposed thermally conductive surface or the second outwardly exposed thermally conductive surface.

13. The method of claim 12, further comprising coupling a flex circuit adjacent to the first end of at least two of the plurality of electrochemical cells, the flex circuit configured to electrically connect the at least two electrochemical cells.

14. The method of claim 9, wherein the outlet is disposed along a top surface of the battery housing.

15. The method of claim 14, wherein the inlet is disposed along the top surface of the battery housing.

16. The method of claim 12, wherein the second end of each of the plurality of electrochemical cells is secured to either the first outwardly exposed thermally conductive surface or the second thermally conductive surface by a thermally conductive epoxy.

17. A system comprising:
at least one flow path for a liquid coolant;
at least one pump for circulating the coolant through the flow path;
at least one heater for heating the coolant in the flow path;
at least one heat exchanger for cooling the coolant in the flow path; and
at least two battery cell supports spaced apart by a flow path, the at least two battery cell supports containing a plurality of electrochemical cells, the electrochemical cells each having a first end and a second end on an opposite side of the first end, the second ends secured in thermal contact with opposing sides of the flow path.

18. The system of claim 17, further comprising a battery housing coupled to the flow path, the battery housing having a plurality of electrochemical cells disposed therein.

19. The system of claim 17, wherein the housing is configured such that coolant from the flow path is in thermal contact with at least two opposing sides of the electrochemical cells disposed therein.

20. The system of claim 18, wherein the plurality of electrochemical cells in the housing are configured to have a higher terminal voltage than the electrochemical cells in the at least two battery cell supports.
